(19) United States
(12) Patent Application Publication
(10) Pub. No.: US 2011/0139972 A1
(43) Pub. Date: Jun. 16, 2011

(54) Methods and Apparatus for Providing FAIMS Waveforms Using Solid-State Switching Devices

(76) Inventors: Mark HARDMAN, Santa Clara, CA (US); Michael W. Belford, Los Altos, CA (US); Jean Jacques Dunyach, San Jose, CA (US)

(21) Appl. No.: 12/636,403

(22) Filed: Dec. 11, 2009

(51) Int. Cl. B01D 59/44; H01J 49/00

(52) U.S. Cl. 250/252.1; 250/283; 250/290

(57) ABSTRACT

A high field asymmetric waveform ion mobility spectrometry (FAIMS) comprises an electrical power supply electrically connected to at least one of the FAIMS electrodes and operable to as to apply a periodic asymmetric square-wave waveform voltage to at least one of the electrodes so as to selectively transmit a type of ion in and through a FAIMS analyzer region to an ion outlet, wherein the electrical power supply is operable so as to vary a time duration of pulses of the asymmetric square-wave waveform so as to control the type of ion selectively transmitted, an efficiency of said selective transmission or the ability to prevent transmission of a different type of ions in and through said analyzer region to the ion outlet.

### FIELD OF THE INVENTION

The instant invention relates generally to high field asymmetric waveform ion mobility spectrometry (FAIMS), and, more particularly, to methods for practicing FAIMS utilizing waveform generator electronics based on switched DC power supplies.

### BACKGROUND OF THE INVENTION

High sensitivity and amenability to miniaturization for field-portable applications have helped to make ion mobility spectrometry (IMS) an important technique for the detection of many compounds, including narcotics, explosives, and chemical warfare agents as described, for example, by G. Eiceman and Z. Karpas in their book entitled “Ion Mobility Spectrometry” (CRC, Boca Raton, 1994). In IMS, gas-phase ion mobilities are determined using a drift tube with a constant electric field. Ions are separated in the drift tube on the basis of differences in their drift velocities. At low electric field strength, for example 200 V/cm, the drift velocity of an ion is proportional to the applied electric field strength, and the mobility, K, which is determined from experimentation, is independent of the applied electric field. Additionally, in IMS, the ions travel through a bath gas that is at sufficiently high pressure that the ions rapidly reach constant velocity when driven by the force of an electric field that is constant both in time and location. This is to be clearly distinguished from those techniques, most of which are related to mass spectrometry, in which the gas pressure is sufficiently low that, if under the influence of a constant electric field, the ions continue to accelerate.

E. A. Mason and E. W. McDaniel in their book entitled “Transport Properties of Ions in Gases” (Wiley, New York, 1988) teach that at high electric field strength, for instance fields stronger than approximately 5000 V/cm, the ion drift velocity is no longer directly proportional to the applied electric field, and K is better represented by K_{H}, a non-constant high field mobility term. The dependence of K_{H} on the applied electric field has been the basis for the development of high field asymmetric waveform ion mobility spectrometry (FAIMS), also occasionally referred to as differential ion mobility spectrometry. Ions are separated in FAIMS on the basis of a difference in the mobility of an ion at high field strength, K_{H}, relative to the mobility of the ion at low field strength, K. In other words, the ions are separated due to the compound dependent behavior of K_{H} as a function of the applied electric field strength.

In general, a device for separating ions according to the FAIMS principle has an analyzer region that is defined by a space between first and second spaced-apart electrodes. The first electrode is maintained at a selected DC voltage, often at ground potential, while the second electrode has an asymmetric waveform V(t) applied to it. The asymmetric waveform V(t) is composed of a repeating pattern including a high voltage component, V_{H}, lasting for a short period of time t_{H} and a lower voltage component, V_{L}, of opposite polarity, lasting a longer period of time t_{L}. The waveform is synthesized such that the integrated voltage-time product, and thus the field-time product, applied to the second electrode during each complete cycle of the waveform is zero. For instance, for a square waveform, this condition becomes:

V_{H}_{^{t}}_{H}+V_{L}_{^{t}}_{L}=0 (Eq. 1)

for example +2000 V for 10 μs followed by −1000 V for 20 μs. The peak voltage during the shorter, high voltage portion of the waveform is called the “dispersion voltage” or DV, which is identically referred to as the applied asymmetric waveform voltage.

Generally, the ions that are to be separated are entrained in a stream of gas flowing through the FAIMS analyzer region, for example between a pair of horizontally oriented, spaced-apart electrodes. Accordingly, the net motion of an ion within the analyzer region is the sum of a horizontal x-axis component due to the stream of gas and a transverse y-axis component due to the applied electric field. During the high voltage portion of the waveform an ion moves with a y-axis velocity component given by

ν_{H}=K_{H}E_{H}, (Eq. 2)

where E_{H} is the applied field, and K_{H} is the high field ion mobility under operating electric field, pressure and temperature conditions. The distance d_{H} traveled by the ion during the high voltage portion of the waveform is given by

d_{H}=ν_{H}t_{H}=K_{H}E_{H}t_{H}, (Eq. 3)

where t_{H} is the time period of the applied high voltage. During the longer duration, opposite polarity, low voltage portion of the asymmetric waveform, the y-axis velocity component of the ion is

ν_{L}=KE_{L}, (Eq. 4)

where K is the low field ion mobility under operating pressure and temperature conditions. The distance traveled is

d_{L}=ν_{L}t_{L}=KE_{L}t_{L}. (Eq. 5)

Since the asymmetric waveform ensures that (V_{H}t_{H})+(V_{L}t_{L})=0, the field-time products E_{H}t_{H} and E_{L}tᵢ, are equal in magnitude. Thus, if K_{H} and K are identical, d_{H} and d_{L} are equal, and the ion is returned to its original position along the y-axis during the negative cycle of the waveform. If at E_{H} the mobility K_{H}>K, the ion experiences a net displacement from its original position relative to the y-axis. For example, if a positive ion travels farther during the positive portion of the waveform, for instance d_{H}>d_{L}, then the ion migrates away from the second electrode and eventually will be neutralized at the first electrode.

FIGS. 1 and 2 are schematic diagrams illustrating the mechanism of ion separation according to the FAIMS principle. An ion 1, for instance a positively charged ion, introduced from ion inlet 23 is carried by a stream of a bath gas 2 flowing between two spaced apart parallel plate electrodes 3 and 4. One of the plates 4 is maintained at ground potential, while the other plate 3 has an asymmetric waveform 10 described by V(t), applied to it from a voltage source 7. The waveform 10 comprises alternating applications of a “high” voltage V_{H} and an opposite polarity “low” voltage V_{L}. The peak voltage V_{H} applied during the waveform is called the dispersion voltage (DV), as is shown in FIG. 2. Referring still to FIG. 2, the waveform 10 is synthesized so that the electric fields during the two periods of time t_{H} and t_{L} are not equal. Because of the requirement that that (V_{H}t_{H})+(V_{L}t_{L})=0, the shaded regions of FIG. 2 comprise equal areas. Under such conditions, then if K_{H} and K are identical, the ion 1 is returned to its original coordinate, with respect to the y-axis (FIG. 1) at the end of one cycle of the waveform. However, under conditions of sufficiently high electric fields, K_{H} is different than K and the distances traveled during the time periods t_{H} and t_{L} are no longer identical. Within an analyzer region defined by a space 16 between the first and second spaced apart electrode plates, 3 and 4, respectively, the ion 1 experiences a net displacement from its original position relative to the plates 3 and 4 as illustrated by the dashed line 5 in FIG. 1.

In operation of the apparatus shown in FIG. 1, ions, such as ion 1, are carried along the longitudinal x-direction by the flow of the bath gas 2. Ions are detected only if they pass through ion outlet 21 (such as an aperture in an aperture plate 8) to a mass analyzer or other detector. If the ion 1 is migrating, along the dashed line 5, away from the upper plate 3, then, in order to direct the ion to the ion outlet 21, a constant negative direct current (DC) compensation voltage CV is applied to plate 3 to reverse or “compensate” for this offset drift. Thus, the ion 1 does not travel toward either plate and follows a trajectory as illustrated by solid line 6 in FIG. 1. If two species of ions respond differently to the applied high electric field, for instance the ratios of K_{H} to K are not identical, the compensation voltages necessary to prevent their drift toward either plate are similarly different. To analyze a mixture of ions, the compensation voltage is, for example, scanned to transmit each of the components of a mixture in turn. This produces a compensation voltage spectrum, or CV spectrum.

When a mixture including several species of ions, each with a unique K_{H}/K ratio, is being analyzed by FAIMS, only one species of ion is selectively transmitted to a detector for a given combination of CV and DV. In one type of FAIMS experiment, the applied CV is scanned with time, for instance the CV is slowly ramped or optionally the CV is stepped from one voltage to a next voltage, and a resulting intensity of transmitted ions is measured. In this way a CV spectrum showing the total ion current as a function of CV, is obtained.

The ideal waveform for a FAIMS device consists of an asymmetric square wave, such as waveform 10 shown in FIG. 2, that comprises a high voltage segment applied for a short period of time, and a lower voltage segment applied for a longer period of time. The integrated voltage-time product of the waveform over one cycle sums to zero. In practice such asymmetric square waveforms are generally not applied to the FAIMS electrodes because of electrical power consumption considerations. Instead, approximations to the ideal square waveform are generally used, such as the waveform 11 shown in FIG. 3. The waveform 11 is generated as a sum of separate sinusoidal waveforms, each separate sinusoidal waveform produced from a resonant tank circuit. An approximation of a square wave may be taken as the first terms of a Fourier series expansion. This waveform is conventionally created by summing two sine waveforms, one at double the frequency of the other. The two sine waves are typically generated by two separate resonant LC (inductance and capacitance) circuits, operating at radio frequency. The amplitudes of the two waveforms must be precisely controlled, as must their relative phase in order to achieve the correct waveform. This precise control adds complication, as the two resonant circuits must be continually monitored and adjusted, usually by adjusting the capacitance in the circuits with electro-mechanical devices.

Further, it is experimentally advantageous to be able to vary the frequency of the FAIMS waveform during a single experiment or set of experiments. However, the frequency of the waveform resulting from sums of separate sinusoidal waves generated in the conventional fashion cannot easily be changed outside of a very narrow range.

### SUMMARY OF THE INVENTION

A novel apparatus and method for providing the asymmetric radio frequency waveform for a FAIMS device is disclosed. An apparatus includes at least first and second direct current (DC) supplies and a switch—which may comprise an analog or a digital device and may comprise a solid-state switch device—electrically coupled to the power supplies and to at least one of the FAIMS electrodes. The switches could be controlled by logic-level pulses supplied by digital control electronics. The DC power supplies can be controlled by analogue control voltages, or digitally. The resulting waveform is a sufficiently close approximation to the ideal square one.

Accordingly, in a first aspect of the invention, there is provided a high field asymmetric waveform ion mobility spectrometry (FAIMS) apparatus for selectively transmitting ions provided by an ionization source, the apparatus comprising: i) an analyzer region defined by a space between first and second spaced apart electrodes, said analyzer region having a gas inlet at a first end and a gas outlet at a second end for providing a flow of gas through said analyzer region, said analyzer region having an ion inlet and an ion outlet, said ion inlet for introducing a flow of ions produced by said ionization source into said analyzer region and said ion outlet for supporting extraction of ions from said analyzer region; and ii) an electrical power supply electrically connected to at least one of said electrodes and operable to as to apply a periodic asymmetric square-wave waveform voltage to at least one of said electrodes so as to selectively transmit a type of ion in and through said analyzer region to the ion outlet, wherein said electrical power supply is operable so as to vary a time duration of pulses of said asymmetric square-wave waveform so as to control the type of ion selectively transmitted, an efficiency of said selective transmission or the ability to prevent transmission of a different type of ions in and through said analyzer region to the ion outlet.

In a second aspect of the invention, there is provided a method for operating a high field asymmetric waveform ion mobility spectrometry (FAIMS) apparatus for selectively transmitting ions provided by an ionization source comprising an analyzer region defined by a space between first and second spaced apart electrodes, said analyzer region having a gas inlet at a first end and a gas outlet at a second end for providing a flow of gas through said analyzer region, said analyzer region having an ion inlet and an ion outlet, said ion inlet for introducing a flow of ions produced by said ionization source into said analyzer region and said ion outlet for supporting extraction of ions from said analyzer region; the method comprising: (a) providing an electrical power supply electrically connected to at least one of said electrodes and operable to as to apply a periodic asymmetric square-wave waveform voltage to at least one of said electrodes so as to selectively transmit a type of ion in and through said analyzer region to the ion outlet; (b) introducing ions from said ionization source into said analyzer region through said ion inlet; (c) applying pulses of said periodic asymmetric square-wave waveform voltage applied to said at least one of said electrodes, said pulses comprising a time duration chosen so as to control the type of ion selectively transmitted, an efficiency of said selective transmission or the ability to prevent transmission of a different type of ions in and through said analyzer region to said ion outlet.

### BRIEF DESCRIPTION OF THE DRAWINGS

The above noted and various other aspects of the present invention will become apparent from the following description which is given by way of example only and with reference to the accompanying drawings, not drawn to scale, in which:

FIG. 1 is a schematic illustration of a conventional FAIMS apparatus;

FIG. 2 is a schematic illustration of an ideal square waveform for operation of a FAIMS apparatus;

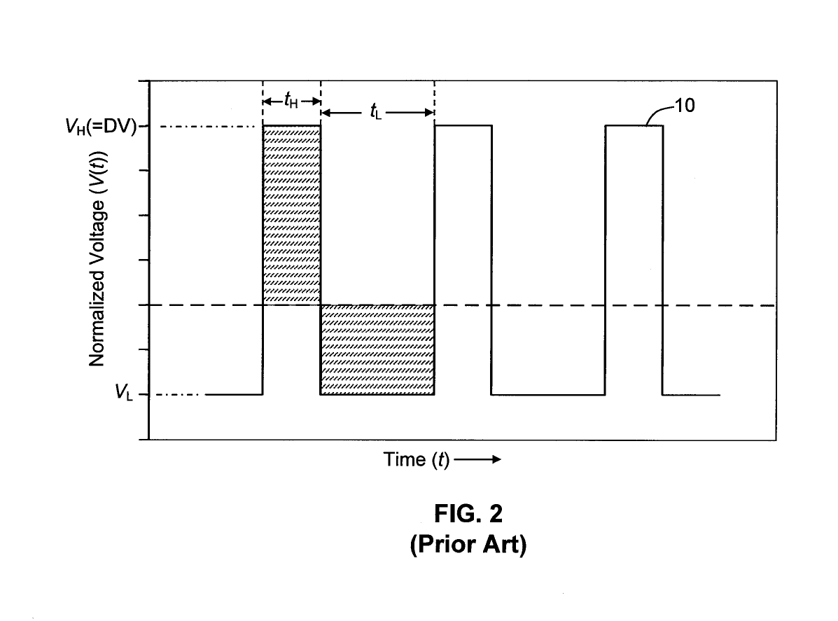

FIG. 3 is a schematic example of a waveform conventionally utilized in operation of a FAIMS apparatus;

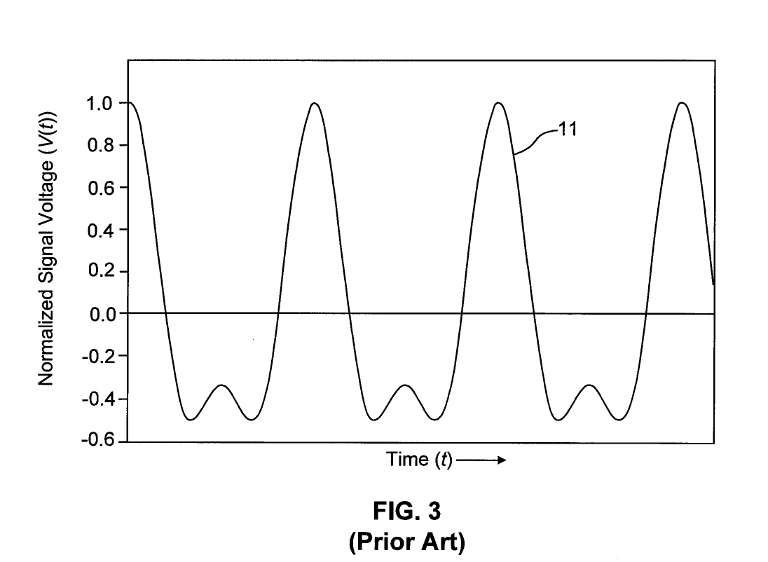

FIG. 4 is an illustration of a FAIMS power supply system in accordance with the invention;

FIG. 5a is a schematic illustration of paths of ions having similar but non-identical mobility through a FAIMS apparatus, in the case of application of a low-frequency asymmetric waveform to an electrode;

FIG. 5b is a schematic illustration of paths of the same ions considered in regard to FIG. 5a, but in the case of application of a high-frequency asymmetric waveform to an electrode;

FIG. 6 is a presentation of flowcharts of two different methods for operating a FAIMS apparatus in accordance with the invention.

### DETAILED DESCRIPTION

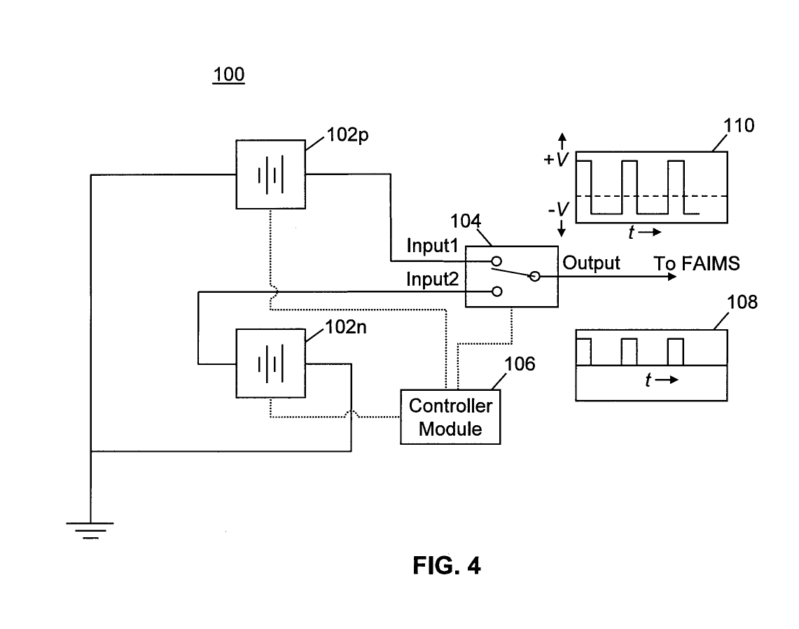

The present invention provides improved methods and apparatus for providing FAIMS waveforms. The following description is presented to enable one of ordinary skill in the art to make and use the invention and is provided in the context of a particular application and its requirements. It will be clear from this description that the invention is not limited to the illustrated examples but that the invention also includes a variety of modifications and embodiments thereto. Therefore the present description should be seen as illustrative and not limiting. While the invention is susceptible of various modifications and alternative constructions, it should be understood that there is no intention to limit the invention to the specific forms disclosed. On the contrary, the invention is to cover all modifications, alternative constructions, and equivalents falling within the essence and scope of the invention as defined in the claims. To more particularly describe the features of the present invention, please refer to FIGS. 4-6 in conjunction with the discussion below.

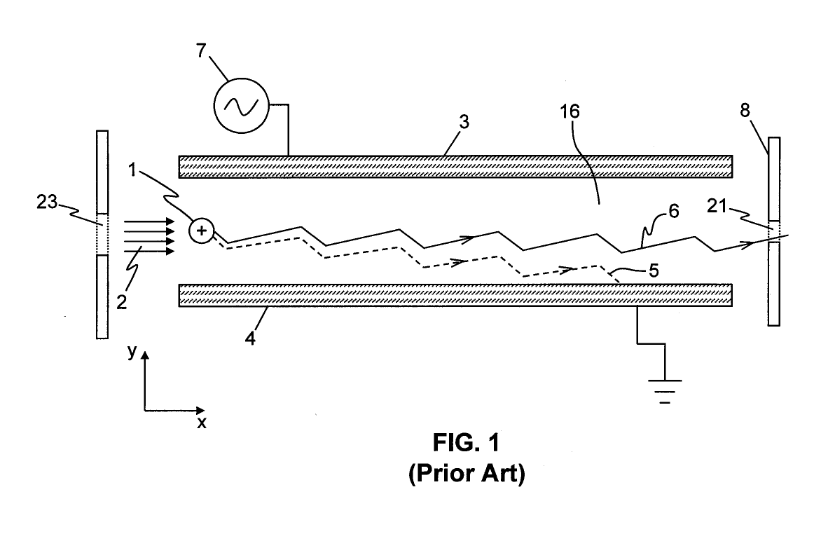

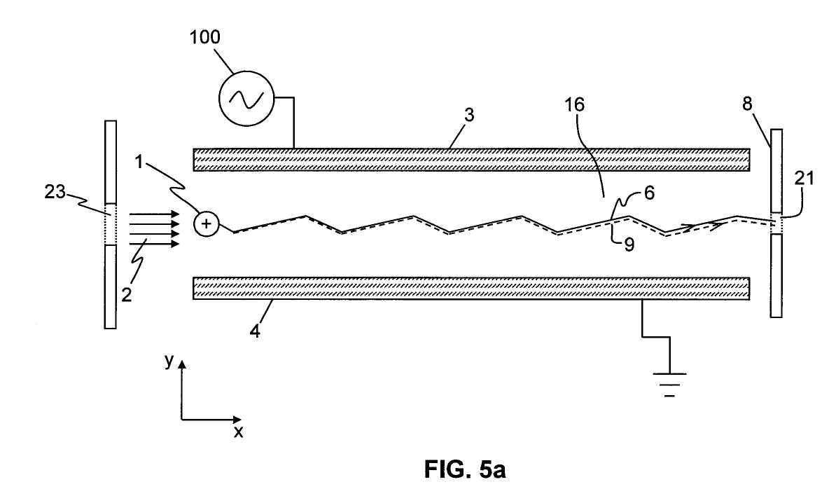

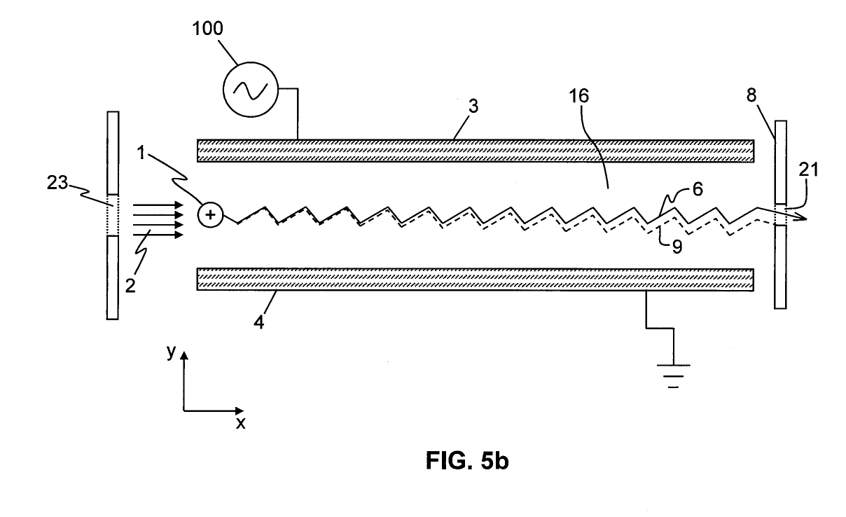

FIG. 4 schematically illustrates a FAIMS power supply system 100 in accordance with the invention. In the system 100, the output of a switch 104 provides a varying dispersion voltage (DV) to a FAIMS electrode (for instance, electrode 3 of FIG. 1, FIG. 5a or FIG. 5b). The switch 104 comprises two electrical inputs, a first input (Input1) on which is provided a first DC voltage supplied by a first DC power supply 102p and a second input (Input2) on which is provided a second different DC voltage supplied by a second DC power supply 102n. The DV output of the switch 104 is determined by alternation of the switch state so as to alternately and repetitively transfer the first DC voltage and the second DC voltage to the switch output, under the control of a controller 106, such as a digital or analog controller, a digital computer or other electronic control device. The controller 106 provides control signals, for instance digital logic level control signals as illustrated in graph 108, to the switch so as to provide a square-wave voltage output, as shown in graph 110. In addition to being electrically coupled to the switch 104, the controller 106 may also be electrically coupled to one or both of the DC power supplies 102p, 102n in a fashion that enables the controller to vary one or both of the DC voltages supplied by the power supplies.

The power supply system 100 provides several advantages relative to a conventional system that generates a conventional sinusoidal waveform. A first advantage is mechanical simplicity with no moving parts, potentially leading to lower cost relative to a conventional system. Another advantage is that the waveform produced is closer to the ideal square one. A third advantage is that the system 100 enables greater operational flexibility and additional operating modes as compared to a conventional system. Still a fourth advantage results from the fact that the design illustrated in FIG. 4 is less susceptible, relative to a conventional system, to thermal drift within the circuits. Thus, it is sufficient to provide DC power supplies and a solid state switch of readily available thermal stability, with no need to frequently monitor the instrumentation for thermal drift and possibly provide compensatory adjustment for such drift, as is the case with conventional power supply circuitry.

As noted above, the system 100 provides advantages of greater operational flexibility and provision of additional operating modes. For example, using the system 100, the frequency of the waveform can easily be varied, as needed, within a very broad range, simply by changing the frequency of switch control pulses. FIGS. 5a and 5b illustrate a situation in which this capability may be usefully employed. In FIGS. 5a and 5b, the hypothetical paths of two different types of ions through a FAIMS apparatus are illustrated. In this example, the two ion types are considered to have similar but non-identical mobility values through a FAIMS apparatus—that is to say, the difference between K_{H} and K taken in regard to the first ion, whose path is indicated by path 6, is similar to the difference between K_{H} and K taken in regard to the second ion, whose path is indicated by path 9. It should be noted that the actual values of K_{H} and K may be significantly different between the two ions, since FAIMS is only sensitive to the difference between these quantities. FIG. 5a illustrates the case of application of a relatively low-frequency asymmetric waveform to an electrode of the FAIMS apparatus. Because the two ions are associated with similar values of the difference quantity (K_{H}−K), there is relatively little separation between the two paths 6, 9 during each application of a single waveform cycle. The separation between the two paths increases with each additional cycle to which the flights of the ions are subjected. However, even after several cycles, the separation may not be sufficient to prevent the ions from passing through the ion outlet 21 to a not-illustrated detector. In such a situation, the two ions may not be resolved during an analysis. However, because of the relatively direct path taken through the apparatus by any ion, the throughput or transmission efficiency of the apparatus for any ion is relatively good.

In the situation illustrated in FIG. 5b, hypothetical pathways of the same two ions are shown, but a relatively high-frequency asymmetric waveform to the electrode. The higher frequency enables the ions to be subjected to a greater number of repetitive cycles of the waveform, thereby increasing the separation of the pathways upon exit of the ions from the apparatus. In the situation illustrated in FIG. 5b, only the first ion is transmitted through the ion outlet 21; the other ion encounters an electrode or plate and is neutralized. In order to detect the second ion, the compensation voltage may be scanned in the usual fashion so that the second ion passes through the ion outlet while the first ion is neutralized by collision with an electrode or plate.

The resolving power of the FAIMS apparatus is the ability of the apparatus to discriminate between transmission of different types of ions in and through the analyzer region to the ion outlet. Thus, from the above discussion, the resolving power of the instrument to analyze ions with different values of (K_{H}−K) is improved by increasing the frequency of the FAIMS waveform. However, with such increased frequency, the throughput or transmission efficiency for any ion is relatively poorer than for the situation in which a lower frequency waveform is applied. The increased resolution could also be achieved by increasing the magnitude(s) of the applied voltage(s). However, driving power requirements increase as the square of the applied voltage but only linearly with frequency.

As described above, the system 100 provides an analyst with the ability to choose waveform frequency that is optimal under any particular experimental conditions so as to best balance the requirements of resolution and throughput. For instance, if the mobilities of two different types of ions are sufficiently different so that the two ions may be resolved (in an ion spectrum generated by a detector coupled to the FAIMS apparatus) under application of a relatively low-frequency waveform, then it may be desirable to not increase the frequency. If sufficient sample material is available, such optimal resolution could be determined, in advance, be performing combined CV and frequency scans—that is, a set of CV scans, each such successive CV scan performed at a respective incrementally modified frequency or, alternatively, a set of frequency scans, each successive frequency scan performed at respective incrementally modified CV value. If candidate ionic species to be analyzed or separated are known beforehand, such a program of combined frequency and CV scanning could form part of an instrument calibration.

Other advantages provided by the system 100 are related to the fact that the ratio between the high voltage value and low voltage value can be varied from the usual 2:1, as can the ratio of the durations of application of the two voltages, by changing the set points of the two DC supplies and the timing of the switch control pulses, respectively. Let the ratio of the applied voltages and the ratio of the time durations be given by the quantities b_{V} and b_{T}, defined as:

$$\begin{matrix}{b}_{V} = \frac{\vert {V}_{H} \vert}{\vert {V}_{L} \vert} = \frac{\vert {E}_{H} \vert}{\vert {E}_{L} \vert} & ( Eq . 6 a ) \\ {b}_{T} = \frac{{t}_{L}}{{t}_{H}} & ( Eq . 6 a )\end{matrix}$$

Note that, in conventional FAIMS, b_{V}=b_{T}=2. Further, let K′_{H} and K′ represent the high-field and low-field mobility constants for a first ion and let K″_{H} and K″ represent the high-field and low-field mobility constants for a second ion.

Considering just the first ion, the magnitude of the distance traversed under application of the low voltage is, as described previously, d′_{L}=K′E_{L}t_{L}. Also, the magnitude of the distance traversed (in the opposite direction) under application of the high voltage is d′_{H}=K′_{H}E_{H}t_{H}=K′_{H}(b_{V}E_{L})(t_{L}/b_{T}). Then, the movement of the first ion, in the y-coordinate (see FIG. 1), induced by application of one full cycle of the asymmetric waveform is given by Δd′, wherein

$$Δ {d}^{′} = ( {d}_{H}^{′} - {d}_{L}^{′} ) = {E}_{L} {t}_{L} ( {K}_{H}^{′} \frac{{b}_{V}}{{b}_{T}} - {K}^{′} ) \qquad ( Eq . 7 a )$$

Likewise, the movement of the second ion, in the y-coordinate, induced by application of one full cycle of the asymmetric waveform is given by Δd″, wherein

$$Δ {d}^{″} = ( {d}_{H}^{″} - {d}_{L}^{″} ) = {E}_{L} {t}_{L} ( {K}_{H}^{″} \frac{{b}_{V}}{{b}_{T}} - {K}^{″} ) \qquad ( Eq . 7 b )$$

The incremental separation, s, between the two ions, induced by a single cycle, is then

$$s = ( Δ {d}^{″} - Δ {d}^{′} ) = {E}_{L} {t}_{L} [ \frac{{b}_{V}}{{b}_{T}} ( {K}_{H}^{″} - {K}_{H}^{′} ) - ( {K}^{″} - {K}^{′} ) ] \qquad ( Eq . 8 )$$

These equations (Eqs. 7a, 7b and Eq. 8) are statements of the well-known result that, in general, each of the two ions will drift, transverse to the flow of bath gas, towards one or another of the two electrodes and that the separation between the two ions will change incrementally upon each cycle of the asymmetric waveform.

As in conventional FAIMS, a variable DC compensation voltage (CV) may be applied to either one of the FAIMS electrodes or may be distributed between the two electrodes in order to counteract the drift of one of the ions so that it may pass through an ion outlet to a detector. However, it is also possible to accomplish a similar result by varying the relative time durations of the high-voltage and low-voltage pulses comprising an asymmetric periodic square wave. For instance, suppose that it is desired to counteract the drift of the second ion, such that the quantity Δd″=0. From Eq. 7b, this condition implies that

$$( {K}_{H}^{″} \frac{{b}_{V}}{{b}_{T}} - {K}^{″} ) = 0$$

and, thus

$$\frac{{b}_{V}}{{b}_{T}} = \frac{{K}^{″}}{{K}_{H}^{″}} \qquad ( Eq . 9 )$$

Eq. 9 shows that either one of the experimental parameters b_{V} or b_{T} (or both) may be adjusted or appropriately chosen, at a fixed frequency, in order to provide drift compensation to the transverse movement of the second ion. Substituting this result into Eq. 7b, it can be shown that, in general, the incremental (i.e., per cycle) transverse drift of the first ion will be non-zero (and thus the two ions may be separated), provided that (K″/K″_{H})≠(K′/K′_{H}).

As another example, it is shown below that the capabilities of independently varying the ratio of high voltage to low voltage and the ratio of high-voltage to low-voltage pulse durations enable a FAIMS apparatus to be used as a simple ion mobility spectrometer, under certain special circumstances. Assume that, within experimental accuracy, the two conditions

(K′_{H}−K′)=(K″_{H}−K″)≠0 (Eq. 10a)

K′≠K″ (Eq. 10b)

can be assumed to hold true, where the mobility constants relate to two different ions, as defined above. Under these circumstances, the ions cannot be separated by conventional FAIMS but can be separated by normal ion mobility spectrometry (IMS). Substituting the equality of Eq. 10a into Eq. 8 yields the relation

$$s = {E}_{L} {t}_{L} ( {K}^{″} - {K}^{′} ) ( \frac{{b}_{V}}{{b}_{T}} - 1 ) \qquad ( Eq . 11 )$$

Eq. 11 shows that the ion separation in the transverse direction, s, is non-zero provided that Eqs. 10a and 10b hold and also provided that the voltages and timing signals are chosen such that b_{V}≠b_{T}. (Note that, in a conventional FAIMS experiment, b_{V}=b_{T}.) The conditions noted in Eqs. 10a and 10b generally also ensure that (K″/K″_{H})≠(K′/K′_{H}). With these conditions met, then the ion separation, s, increases in magnitude with either increasing b_{V} or decreasing b_{T}. The apparatus 100 permits such voltages and timing signals to be chosen and applied, accordingly.

As in a normal FAIMS experiment, when a FAIMS analyzer is used as a simple ion mobility spectrometer in accordance with the conditions (Eqs. 7a and 7b) described above, both the first and second ions will, in general, drift away from a region (for instance, a plane or other surface) that is mid-way between the electrodes and, in the absence of further intervention, will eventually encounter an electrode or other surface so as to be neutralized. Such neutralized ions will not pass through an ion outlet aperture and will not be detected. As described previously, a DC compensation voltage may be supplied to either (or both) of the FAIMS electrodes. Alternatively, the ratio (b_{V}/b_{T}) may be varied in order to counteract the drift of one of the ions, as described above.

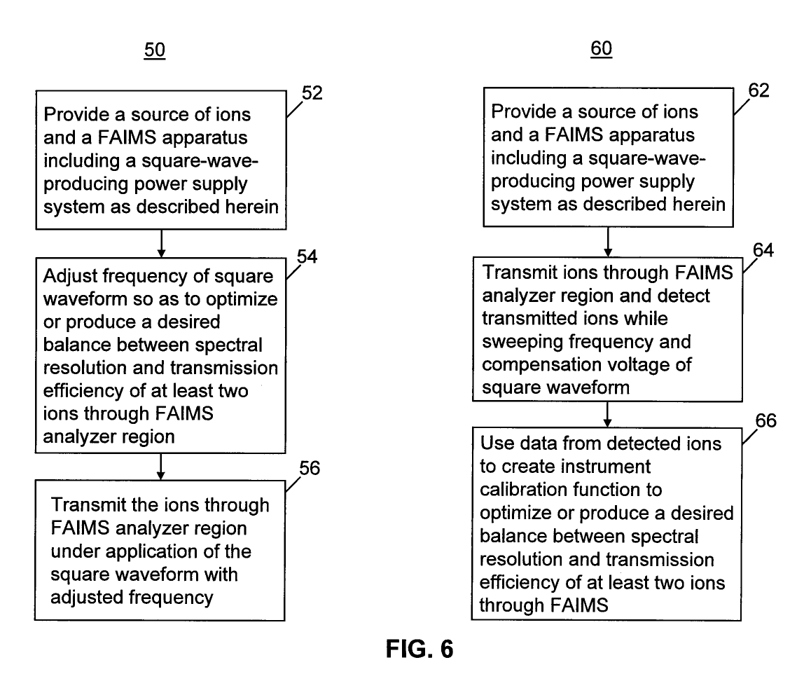

FIG. 6 presents flowcharts of two methods in accordance with the invention. A first method 50 relates to optimization of FAIMS operating conditions so as to provide an optimal balance between resolution and throughput. In step 52 of method 50, a source of ions and a FAIMS apparatus in accordance with the invention are provided. The FAIMS apparatus comprises first and second spaced apart electrodes that define an analyzer region in the space between the electrodes. The apparatus further comprises a gas inlet at a first end and a gas outlet at a second end for providing a flow of gas through the analyzer region. The analyzer region comprises both an ion inlet for introducing a flow of ions produced by the ionization source into the analyzer region and an ion outlet. Still referring to step 52 of method 50, it is noted that the FAIMS apparatus further comprises an electrical power supply system as illustrated in and discussed in reference to FIG. 4 having at least a switch whose output is electrically connected to at least one of the electrodes, two DC power supplies electrically connected to separate switch inputs, and a controller module electrically connected to at least the switch and optionally to one or both of the DC power supplies. The power supply system is capable of applying an asymmetric square-wave waveform voltage and a direct-current compensation voltage to selectively transmit a type of ion in the analyzer region at a given combination of asymmetric waveform voltages and compensation voltages. The power supply system is further capable of varying the frequency of the square-wave waveform by varying the time durations of applied high-voltage and low-voltage pulses and, optionally, capable of varying the magnitudes of the high and low voltages.

In the next step, step 54 of the method 50, the frequency of an asymmetric square waveform to be applied to the FAIMS apparatus is adjusted so as to optimize or produce a desired balance between spectral resolution and throughput of at least two ions through the FAIMS analyzer region. In this situation, possible analyte ions in a sample are either known or hypothesized and the frequency is adjusted so as to either maximize detection resolution of such ions, to maximize transmission efficiency of the ions, or to produce a best or desired balance between spectral resolution and transmission efficiency. In the subsequent step 56, ions are transmitted through the FAIMS analyzer region (so as to be detected) under application of the square waveform with the adjusted frequency.

A second method 60 presented in FIG. 6 relates to calibration of FAIMS operating conditions so as to provide an optimal balance between resolution and throughput. In this situation, analyte ions are introduced into a FAIMS analyzer under controlled conditions, wherein the identities and quantities of the various are known in advance, and an instrument calibration is developed. Such an instrument calibration may later be consulted by a FAIMS user during analysis of an unknown sample so as adjust instrument operating conditions to either maximize detection resolution of candidate ions, to maximize transmission efficiency of the candidate ions, or to produce a best or desired balance between spectral resolution and transmission efficiency of the candidate ions.

In the first step, step 62 of the method 60 (FIG. 6), a source of ions and a FAIMS apparatus in accordance with the invention are provided. The FAIMS apparatus is configured as already described in reference to the method 50. In the next step, step 64, the ions are transmitted through the FAIMS analyzer region so as to be detected by a detector, while sweeping both the frequency and compensation voltage of a square waveform applied to the FAIMS. The combined frequency and voltage sweeps may be performed by performing a set of scans over CV, wherein each such successive CV scan is performed at a respective incrementally modified frequency. Alternatively, a set of scans over frequency may be performed, wherein each successive frequency scan is performed at respective incrementally modified CV value. The result of these scans is a data set resulting from the detection of the ions as relating to applied frequency and CV. This data is used to create an instrument calibration function or database that can be subsequently consulted and used by an analyst to optimize or produce a desired balance between spectral resolution and FAIMS throughput when analyzing an unknown sample. Both the creation and use of the database may be implemented in software.

The discussion included in this application is intended to serve as a basic description. Neither the description nor the terminology is intended to limit the scope of the invention. The reader should be aware that the specific discussion may not explicitly describe all embodiments possible; many alternatives are implicit. Further, each feature or element can actually be representative of a broader function or of a great variety of alternative or equivalent elements. Again, these are implicitly included in this disclosure. Thus, a variety of changes may be made without departing from the essence of the invention. Such changes are also implicitly included in the description. As but one example, although the present description of the invention has made reference to FAIMS apparatuses having flat plate electrodes (e.g., see FIGS. 1, 5a, 5b), one of ordinary skill in the art will recognize that the invention includes FAIMS apparatus having electrodes with other geometries—e.g., stacked plates, concentric cylinders, domed-cylinders, spheres ellipsoids, etc. Finally, note that any publications, patents or patent application publications mentioned in this specification are explicitly incorporated by reference in their respective entirety.

What is claimed is:

1. A high field asymmetric waveform ion mobility spectrometry (FAIMS) apparatus for selectively transmitting ions provided by an ionization source, the apparatus comprising:
i) an analyzer region defined by a space between first and second spaced apart electrodes, said analyzer region having a gas inlet at a first end and a gas outlet at a second end for providing a flow of gas through said analyzer region, said analyzer region having an ion inlet and an ion outlet, said ion inlet for introducing a flow of ions produced by said ionization source into said analyzer region and said ion outlet for supporting extraction of ions from said analyzer region; and
ii) an electrical power supply electrically connected to at least one of said electrodes and operable to as to apply a periodic asymmetric square-wave waveform voltage to at least one of said electrodes so as to selectively transmit a type of ion in and through said analyzer region to the ion outlet,
wherein said electrical power supply is operable so as to vary a time duration of pulses of said asymmetric square-wave waveform so as to control the type of ion selectively transmitted, an efficiency of said selective transmission or the ability to prevent transmission of a different type of ions in and through said analyzer region to the ion outlet.

2. An apparatus as recited in claim 1, wherein said electrical power supply is further operable so as to vary a voltage level of said pulses.

3. An apparatus as recited in claim 1, wherein said electrical power supply comprises:
a) a switch comprising a first input, a second input and an output, said output electrically coupled to the at least one of said electrodes; and
b) a first direct current (DC) power supply electrically connected to the first switch input; and
(c) a second direct current (DC) power supply electrically connected to the second switch input,
wherein the switch is operable so as to alternately provide power from the first DC power supply and the second DC power supply to the at least one of said electrodes.

4. A method for operating a high field asymmetric waveform ion mobility spectrometry (FAIMS) apparatus for selectively transmitting ions provided by an ionization source comprising an analyzer region defined by a space between first and second spaced apart electrodes, said analyzer region having a gas inlet at a first end and a gas outlet at a second end for providing a flow of gas through said analyzer region, said analyzer region having an ion inlet and an ion outlet, said ion inlet for introducing a flow of ions produced by said ionization source into said analyzer region and said ion outlet for supporting extraction of ions from said analyzer region; the method comprising:
(a) providing an electrical power supply electrically connected to at least one of said electrodes and operable to as to apply a periodic asymmetric square-wave waveform voltage to at least one of said electrodes so as to selectively transmit a type of ion in and through said analyzer region to the ion outlet;
(b) introducing ions from said ionization source into said analyzer region through said ion inlet; and
(c) applying pulses of said periodic asymmetric square-wave waveform voltage applied to said at least one of said electrodes, said pulses comprising a time duration chosen so as to control the type of ion selectively transmitted, an efficiency of said selective transmission or the ability to prevent transmission of a different type of ions in and through said analyzer region to said ion outlet.

5. A method as recited in claim 4, wherein the step (b) of applying pulses of said periodic asymmetric square-wave waveform voltage applied to said at least one of said electrodes comprises applying a chosen frequency of said periodic asymmetric square-wave waveform voltage applied to said at least one of said electrodes, said frequency chosen to as to provide an optimal or desired resolving power of the FAIMS apparatus.

6. A method as recited in claim 4, wherein the step (b) of applying pulses of said periodic asymmetric square-wave waveform voltage applied to said at least one of said electrodes comprises applying a chosen voltage of said pulses, said voltage chosen to as to provide an optimal or desired resolving power of the FAIMS apparatus.

7. A method as recited in claim 4, wherein the step (a) of providing an electrical power supply electrically connected to at least one of said electrodes comprises:
(a1) providing a first and a second direct current (DC) power supply;
(a2) providing a switch electrically coupled to the first and second DC power supplies and to the at least one of said electrodes; and
(a3) operating the switch so as to alternately provide power from the first DC power supply and the second DC power supply to the at least one of said electrodes.

8. The method of claim 4, wherein the step (a) of providing an electrical power supply electrically connected to at least one of said electrodes further comprises:
(a4) providing a digital controller electrically coupled to the switch; and
(a5) providing signals from the digital controller to the switch so as to operate the switch.

9. A method for operating a high field asymmetric waveform ion mobility spectrometry (FAIMS) apparatus for selectively transmitting ions provided by an ionization source comprising an analyzer region defined by a space between first and second spaced apart electrodes, said analyzer region having a gas inlet at a first end and a gas outlet at a second end for providing a flow of gas through said analyzer region, said analyzer region having an ion inlet and an ion outlet, said ion inlet for introducing a flow of ions produced by said ionization source into said analyzer region and said ion outlet for supporting extraction of ions from said analyzer region; the method comprising:
(a) providing an electrical power supply electrically connected to at least one of said electrodes and operable to as to apply a periodic asymmetric square-wave waveform voltage to at least one of said electrodes so as to selectively transmit a type of ion in and through said analyzer region to the ion outlet;
(b) introducing a stream of ions from said ionization source into said analyzer region through said ion inlet;
(c) applying said periodic asymmetric square-wave waveform voltage applied to said at least one of said electrodes while systematically varying a frequency of said applied waveform; and
(d) detecting ions transmitted through the ion outlet during application of the periodic asymmetric square-wave waveform and the systematic frequency variation.

10. A method as recited in claim 9, wherein the step (c) applying said periodic asymmetric square-wave waveform voltage applied to said at least one of said electrodes includes systematically varying a voltage of said applied waveform.

11. A method as recited in claim 9, further comprising:
(e) using the detection to generate an instrument calibration function or database.
